(19) United States
(12) Patent Application Publication
(10) Pub. No.: US 2026/0254491 A1
(43) Pub. Date: Aug. 27, 2026

(54) UPLINK POWER CONSTRAINT CAPABILITY WITH ANALOG BEAMFORMING

(71) Applicant: QUALCOMM Incorporated, San Diego, CA (US)

(72) Inventors: Vasanthan RAGHAVAN, West Windsor Township, NJ (US); Juergen CEZANNE, Ocean Township, NJ (US)

(21) Appl. No.: 19/065,868

(22) Filed: Feb. 27, 2025

(51) Int. Cl. H04B 7/06; H04W 52/14; H04W 52/36

(52) U.S. Cl. CPC H04B 7/0617; H04W 52/146; H04W 52/367

(57) ABSTRACT

Apparatus, methods, and computer program products for wireless communication are provided. An example method may include transmitting, to a network entity, a dynamic UE capability that indicates a potential of upgrading a power class based on a usage of an uplink analog beamforming (ABF) scheme. The example method may further include transmitting, to the network entity, an uplink transmission based on the uplink ABF scheme with the upgraded power class. The example method may further include receiving, from the network entity, an indication to reduce an uplink transmit power after transmission of the uplink transmission.

### TECHNICAL FIELD

The present disclosure relates generally to communication systems, and more particularly, to wireless communication systems with analog beamforming (ABF).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) transmit, to a network entity, a dynamic UE capability that indicates a potential of upgrading a power class of the device based on a usage of an uplink analog beamforming (ABF) scheme. Based at least in part on information stored in the at least one memory, the at least one processor, individually or in any combination, is configured to transmit, to the network entity, an uplink transmission based on the uplink ABF scheme with the upgraded power class.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to receive, from a user equipment (UE), a dynamic UE capability that indicates a potential of upgrading a power class of the device based on a usage of an uplink analog beamforming (ABF) scheme. Based at least in part on information stored in the at least one memory, the at least one processor, individually or in any combination, is configured to receive, from the UE, an uplink transmission based on the uplink ABF scheme. Based at least in part on information stored in the at least one memory, the at least one processor, individually or in any combination, is configured to transmit, for the UE, an indication to reduce an uplink transmit power based on a power of the uplink transmission being above a threshold.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating a network node in communication with a UE via a set of beams, in accordance with various aspects of the present disclosure.

FIG. 5 is a diagram illustrating an example of a first wireless device that transmits a beam and a second wireless device that receives the beam, in accordance with various aspects of the present disclosure.

FIG. 6 is a diagram illustrating example communications between a network entity and a UE.

FIG. 7 is a flowchart of a method of wireless communication.

FIG. 8 is a flowchart of a method of wireless communication.

FIG. 9 is a diagram illustrating an example of a hardware implementation for an example apparatus and/or network entity.

FIG. 10 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

To improve performance of uplink analog beamforming (ABF), aspects provided herein enables a user equipment (UE) to report a dynamic capability that indicates a potential of upgrading a power class of the UE when uplink ABF is being used, instead of a static capability that has a fixed power class associated with each frequency range supported by the UE. By enabling more flexible uplink ABF with power class upgrading/downgrading potential, the performance gain realized by ABF may be better. The network may dynamically instruct the UE to adjust its power class (such as downgrading the power class) due to potential interference that may be caused by the upgraded power class (e.g., interference to potential victim nodes in the network).

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

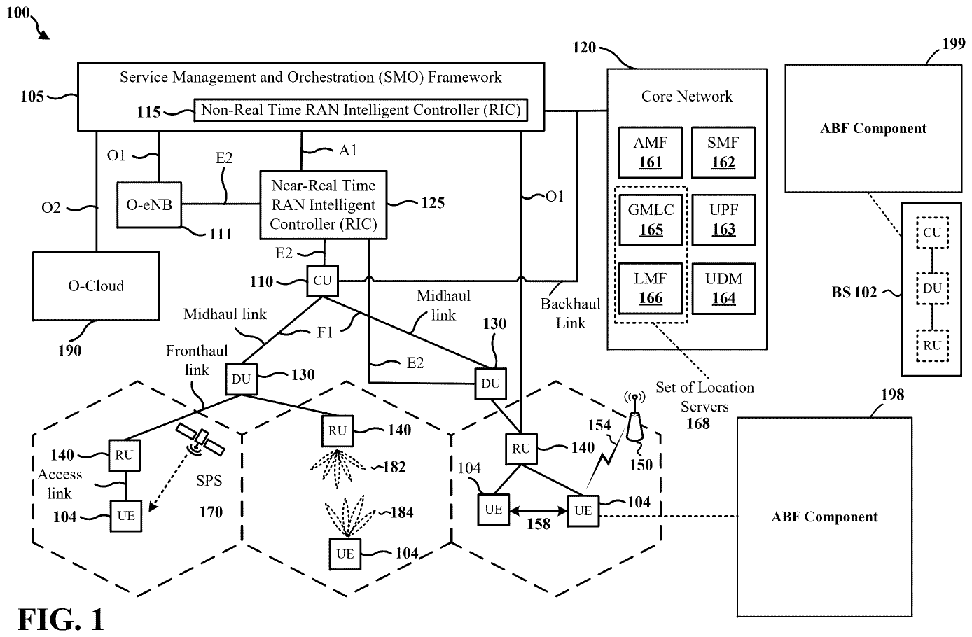

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include an ABF component 198. In some aspects, the ABF component 198 may be configured to transmit, to a network entity, a dynamic UE capability that indicates a potential of upgrading a power class of the device (e.g., the UE 104 itself) based on a usage of an uplink ABF scheme. In some aspects, the ABF component 198 may be further configured to transmit, to the network entity, an uplink transmission based on the uplink ABF scheme with the upgraded power class.

In certain aspects, the base station 102 may include an ABF component 199. In some aspects, the ABF component 199 may be configured to receive, from a UE, a dynamic UE capability that indicates a potential of upgrading a power class based on a usage of an uplink ABF scheme. In some aspects, the ABF component 199 may be further configured to receive, from the UE, an uplink transmission based on the uplink ABF scheme. In some aspects, the ABF component 199 may be further configured to transmit, for the UE, an indication to reduce an uplink transmit power based on a power of the uplink transmission being above a threshold.

Although the following description may be focused on 5G NR, the concepts described herein may be applicable to other similar areas, such as 6G, LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

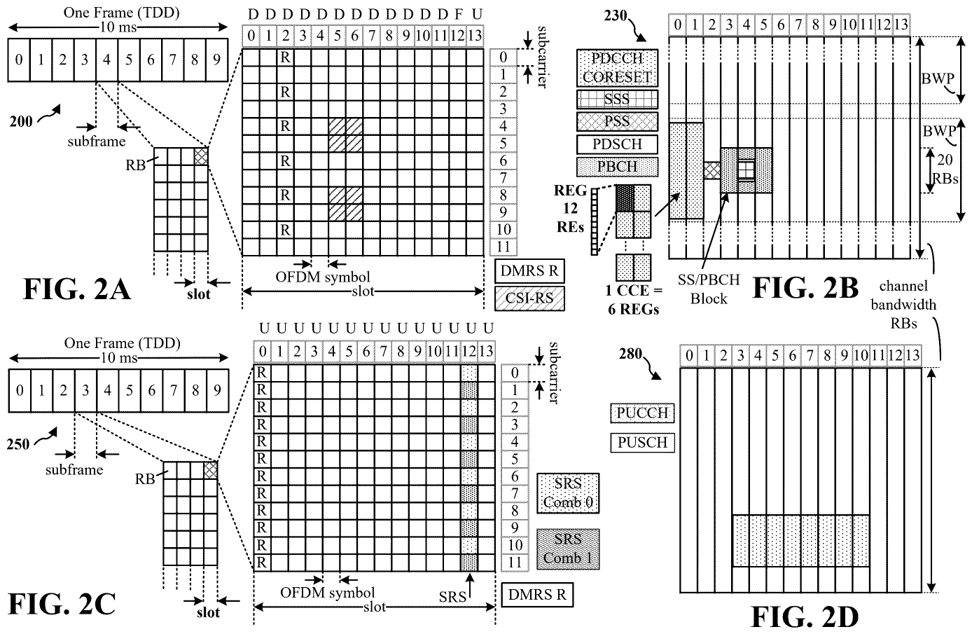

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies u 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

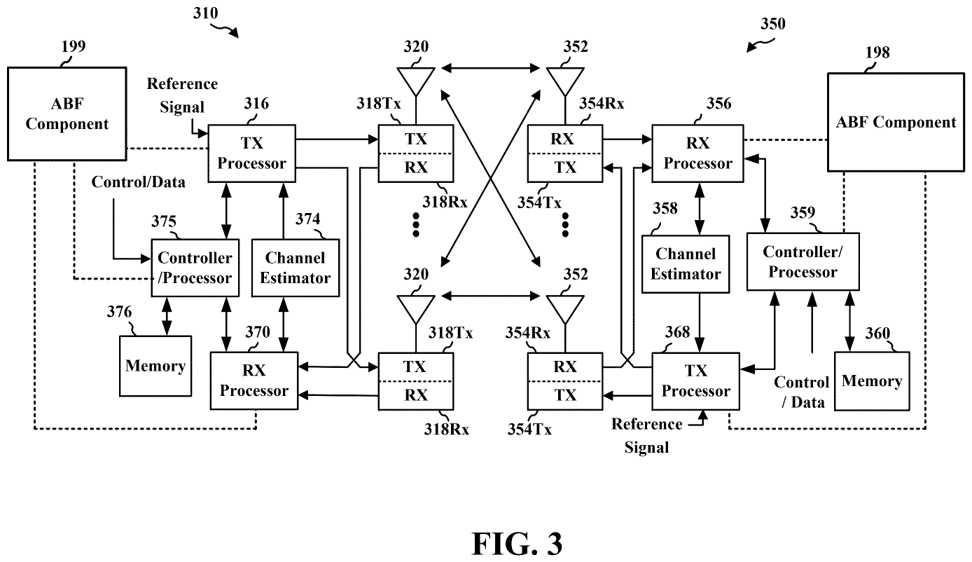

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with ABF component 198 of FIG. 1.

At least one of the TX processor 316, the RX processor 370, and the controller/processor 375 may be configured to perform aspects in connection with ABF component 199 of FIG. 1.

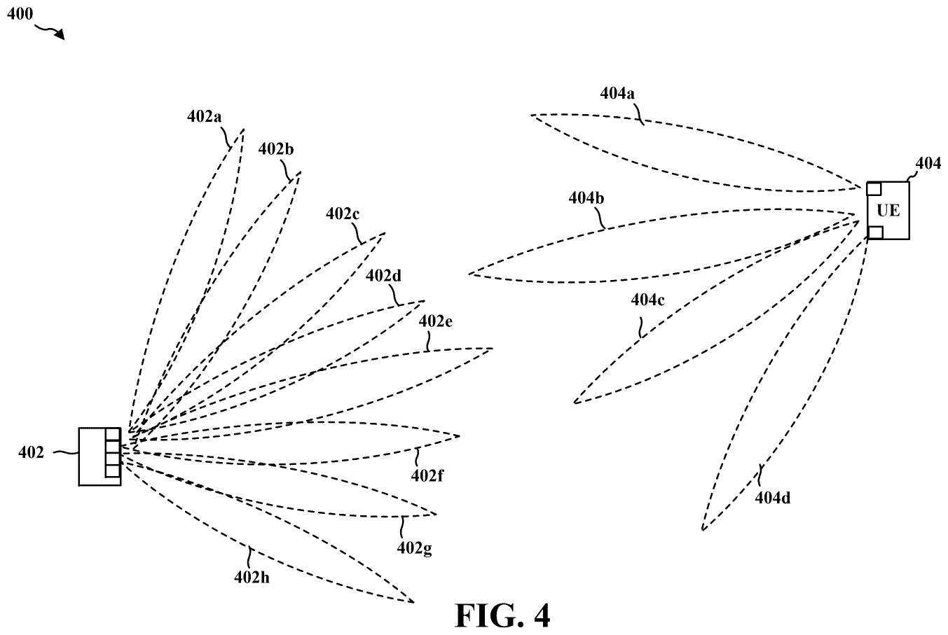

FIG. 4 is a diagram 400 illustrating a network node 402 in communication with a UE 404. Referring to FIG. 4, the network node 402 may transmit a beamformed signal to the UE 404 in one or more of the directions 402a, 402b, 402c, 402d, 402e, 402f, 402g, 402h. The UE 404 may receive the beamformed signal from the network node 402 in one or more receive directions 404a, 404b, 404c, 404d. The UE 404 may also transmit a beamformed signal to the network node 402 in one or more of the directions 404a-404d. The network node 402 may receive the beamformed signal from the UE 404 in one or more of the receive directions 402a-402h. The network node 402/UE 404 may perform beam training to determine the best receive and transmit directions for each of the network node 402/UE 404. The transmit and receive directions for the network node 402 may or may not be the same. The transmit and receive directions for the UE 404 may or may not be the same. The term beam may be otherwise referred to as “spatial filter.” Beamforming may be otherwise referred to as “spatial filtering.” As used herein, the term “beam” may correspond to “spatial filter.”

In response to different conditions, the UE 404 may determine to switch beams, e.g., between beams 402a-402h. The beam at the UE 404 may be used for reception of downlink communication and/or transmission of uplink communication. In some examples, the network node 402 may send a transmission that triggers a beam switch by the UE 404. A TCI state may include quasi-co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a Quasi co-location (QCL) relationship between DL RSs in one RS set and PDSCH/PDCCH DM-RS ports. information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. For example, the network node 402 may indicate a TCI state change, and in response, the UE 404 may switch to a new beam according to the new TCI state indicated by the network node 402.

In some wireless communication systems, such as a wireless communication system under a unified TCI framework, a pool of joint DL/UL TCI states may be used for joint DL/UL TCI state updates for beam indication. For example, the network node 402 may transmit a pool of joint DL/UL TCI states to the UE 404. The UE 404 may determine to switch transmission beams and/or reception beams based on the joint DL/UL TCI states. In some aspects, the TCI state pool for separate DL and UL TCI state updates may be used. In some aspects, the network node 402 may use RRC signaling to configure the TCI state pool. In some aspects, the joint TCI may or may not include UL-specific parameter(s) such as UL PC/timing parameters, PL RS, panel-related indication, or the like. If the joint TCI includes the UL-specific parameter(s), the parameters may be used for the UL transmission of the DL and UL transmissions to which the joint TCI is applied.

Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like.

A TCI state may be defined to represent at least one source RS to provide a reference (e.g., UE assumption) for determining quasi-co-location (QCL) or spatial filters. For example, a TCI state may define a QCL assumption between a source RS and a target RS.

To accommodate situations where beam indication for UL and DL are separate, two separate TCI states (one for DL and another one for UL) may be utilized. For a separate DL TCI, the source reference signal(s) in M (M being an integer) TCIs may provide QCL information at least for UE-dedicated reception on PDSCH and for UE-dedicated reception on all or subset of CORESETs in a CC. For a separate UL TCI, the source reference signal(s) in N (N being an integer) TCIs provide a reference for determining common UL transmission (TX) spatial filter(s) at least for dynamic-grant or configured-grant based PUSCH and all or subset of dedicated PUCCH resources in a CC.

One type of beamforming may include codebook-based beam scanning. A codebook may include information corresponding to a beam used for communication, such as a beam index, direction, beam weights across antennas, antenna ordering information, beam steering information (e.g., angles in azimuth and/or zenith), and/or other information associated with a beam. For example, a codebook may include a collection of beamforming vectors (e.g., fixed or predefined beamforming vectors), as well as techniques for generating and/or combining vectors (both static as well as dynamic). Beamforming codebooks may be either designed for rank-1 analog beamforming or for higher rank precoding applications. An example of a codebook may include a matrix of beam weights with different column vectors corresponding to the weights used across different antennas for a certain layer of data transmission.

Another type of beamforming may be non-codebook based, which may be referred to as “dynamic beamforming.” For dynamic beamforming in uplink, SRS may be sent from UE to the RU, and the RU may transmit raw SRS samples to DU so that the DU may perform spatial processing on these samples and compute beamforming weights, which may also be referred to as “beam weights.”

A UE may report various metrics with regard to at least one beam. For example, the metrics may include reference signal received power (RSRP), signal to interference and noise ratio (SINR), rank indicator (RI), precoding matrix indicator (PMI), channel quality indicator (CQI), or other metrics with regard to at least one beam. A transmission carrying the metrics with regard to a beam may be referred to as a “beam report.”

A UE may perform UE-initiated (which may also be referred to as “event-driven”) beam reporting. For UE-initiated beam reporting, the UE may perform beam reporting based on detection of an event. As a first example, an event may be based on a quality of the current beam being worse than a threshold. As a second example, an event may be based on a quality of at least one new beam, such as layer 1 (L1) reference signal received power (RSRP), becomes a threshold value better than the current beam. As a third example, an event may be based on a quality of a new beam is better than a threshold. As a fourth example, an event may be based on a quality of the current beam is worse than a first threshold, and quality of at least one new beam is better than a second threshold. As used herein, the term “event” may refer to a situation with regard to a beam that upon detection, may trigger beam reporting by the UE. As a particular example, a particular type of event instance may be referred to as “Event-2 instance” for a new beam (a candidate beam) where the UE may determine the event-2 instance if the physical layer (layer 1 (L1)) RSRP of the new beam becomes a threshold value better than the current beam (the current serving beam). In some aspects, for a UE that supports UE initiated beam report, if within a time window (which is configurable by the network node), the number of Event-2 instance(s) for at least one same new beam is greater than or equal to a configurable number M, UE initiated beam report may occur.

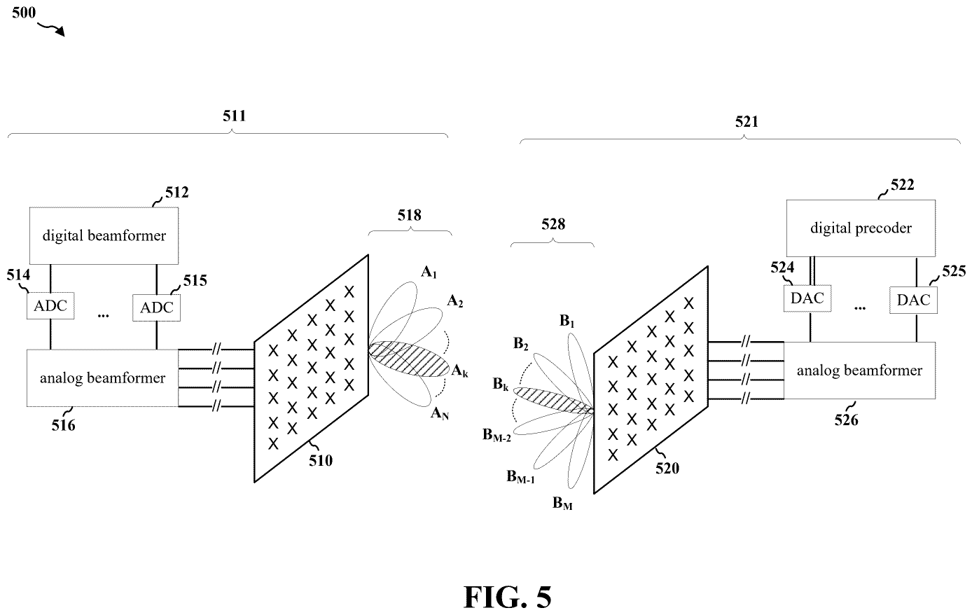

FIG. 5 is a diagram 500 illustrating an example of a wireless device 521 that transmits a beam using a panel 520 and a wireless device 511 that receives the beam using the panel 510. The wireless device 521 may be a UE, such as the UE 104 in FIG. 1 or the UE 404 in FIG. 4, or a network node, such as the base station 102 in FIG. 1 or the network node 402 in FIG. 4. The wireless device 511 may be a UE, such as the UE 104 in FIG. 1 or the UE 404 in FIG. 4, or a network node, such as the base station 102 in FIG. 1 or the network node 402 in FIG. 4. In some aspects, the wireless device 521 may be a UE and the wireless device 511 may be a base station, and the wireless device 521 may receive a downlink transmission from the wireless device 511.

The wireless device 521 may have a digital precoder 522 that may be configured to encode data that is fed to a series of digital to analog converters (DACs) 524 to 525. The data from the digital precoder 522 may be represented by a digital precoding matrix P, or N_{TP}×N_{SS}. The DACs may provide analog signals to the analog beamformer 526. The analog signals from the analog beamformer 526 may be represented by a transmission analog beamforming matrix B, or N_{Tx}×N_{TP}. The analog beamformer 526 may form beams, which may be provided to the panel 520 having a plurality of elements that form a series of beams 528 in a channel, illustrated as beams B₁ to B_{M}. The wireless device 511 may monitor the beams 518 in a channel, illustrated as beams A₁ to A_{N}. The channel matrix between the panel 520 and the panel 510 may be represented as a raw channel matrix H, or N_{Rx}×N_{Tx}. The raw channel matrix H may be defined by at least one of a function of core parameters, a number of clusters and per cluster AoA, a number of clusters and per cluster AoD, a number of clusters and per cluster zone of arrival (ZoA), a number of clusters and per cluster zone of departure (ZoD), delays, or powers. The signal received by the panel 510 may be provided to the analog beam former 516. The analog beam signal formed by the analog beam former 516 may be represented by a reception analog beamforming matrix A, or N_{RP}×N_{Rx}. The analog beam signal may be fed through the analog to digital converters (ADCs) 514 to 515, which may then feed the digital signal to the digital beamformer 512 for processing. The hybrid beamforming input/output relationship per tone for the transmission from the wireless device 521 to the wireless device 511 may be represented as y=AHBPx+n, where x may be the input signal and n may be noise received by the panel 510.

The wireless device 511 and/or the wireless device 521 may use a plurality of Tx and Rx beamformed measurements, such as AᵢHBⱼ to infer some information about the raw channel H. In some aspects, the wireless device 511 and/or the wireless device 521 may use dynamic codebook adaptation to create custom non-codebook-based analog beams to improve a capacity of the beams. In another aspect, the wireless device 511 and/or the wireless device 521 may predict an oversampled codebook index through non-oversampled codebook measurements to reduce an overhead of the transmitted and received beams. The series of beams 528 may have a beam Bₖ that represents the strongest transmission beam from the panel 520 to the panel 510. The series of beams 518 may have a beam Aₖ that represents the strongest reception beam monitored by the panel 510 from the panel 520. With beam shape information from the wireless device 521, the wireless device 511 may be able to estimate at least one of the AoD of the beam Bk and the AoA of the beam Aₖ to determine the strongest beam pair between the panel 510 and the panel 520. With beam zone information from the wireless device 521, the wireless device 511 may be able to estimate the ZoD of the beam Bₖ and the ZoA of the beam Aₖ to determine the strongest zone pair between the panel 510 and the panel 520. One way to analyze the beams transmitted by the panel 520 and received by the panel 510 may be dividing the angular space at the wireless device 521 and the wireless device 511 into grids.

Analog beamforming (ABF) may involve the use of phase shifters and/or amplitude control to co-phase antenna elements that may or may not form an antenna array at a radio frequency (RF) of interest. As an example, ABF may be used in some frequency ranges (e.g., FR2/mmWave frequencies) for improving the link budget that may be impaired with increased blockage, penetration, and path losses. The antennas may be a priori grouped across polarizations in an antenna module. Using the ABF in other frequency ranges, such as FR1 or FR3, may involve more search or signaling overhead due to characteristics of the antennas used for these frequency ranges. However, using the ABF in those frequency ranges may still be feasible for reducing power associated with an increased performance. On the uplink side, performance of ABF is related to the type of RF architecture used at the UE side.

In wireless communication systems, a UE may be associated with a power class for each frequency range (e.g., each band supported by the UE). The UE may transmit information regarding its power class associated with each band to the network at the start of a session in a UE capability signaling. The term “power class” may refer to a categorization of the UE that may be based on the maximum transmit power level that the UE may output for a frequency range (e.g., band) associated with the power class. By way of example, power class 1 may be up to 31 decibel milliwatts (dBm), power class 2 may be up to 26 dBm, power class 3 may be up to 23 dBm, and power class 4 may be up to 20 dBm. In some wireless communication systems, the power classes associated with each band supported by the UE may be static (i.e., not adjustable due to channel or operation conditions) and depends on the device itself (e.g., and not dependent on external factors).

As mentioned herein, ABF corresponds to the use of phase shifter and/or amplitude control to improve power-performance tradeoffs. For example, the UE may have four antennas with two layers where two antennas are ABFed per layer. With two layers used, more SNR can be realized per layer with ABF of two antennas compared to using one antenna per layer. ABF may produce gains on DL as well as UL. For UL ABF, the amount of possible gains depends on the channel profile used, as well as the UE power characteristics. For example, in a first scenario, a UE may be subject to a total conducted or radiated power constraint across all antennas associated with the UE (i.e., the “total power constraint”) that may be independent of whether ABF is used or not. In other words, the UE may have a same total conducted or radiated power constraint regardless of whether ABF is used or not and the UE may have to remain in a same power class regardless of whether ABF is used or not. The use of ABF is treated as UE implementation and does not impact the capability of the device. Each antenna may have its own power amplifier (PA) such that the peak power of the PA in the linear region adds to a power constraint in both ABF and no ABF modes. In formula form, this may correspond to:

$${\sum }_{i in ABF} {P}_{i} \leq {P}_{CMAX} and {\sum }_{i in no ABF} {P}_{i} \leq {P}_{CMAX} ,$$

where Pᵢ denotes the power transmitted by the i^{th} antenna element and P_{CMAX} denotes the maximum allowed transmission power as defined by the power class. In a second scenario, the UE may be subject to a maximum power useable per antenna constraint (i.e., the “maximum power per antenna constraint”) where the UE may be capable of being in one power class when no ABF is being used and may be in an upgraded power class (i.e., a power class with a higher maximum transmit power) when ABF is being used. In other words, each antenna may have an independent PA with the same peak power rating. Therefore, more power can be realized when ABF is used compared to scenarios where no ABF is used because more antennas are used in ABF. In formula form, this may correspond to: Pᵢ≤P_{CMAX} where the P_{CMAX} in this scenario may be different from the P_{CMAX} in the previous scenario.

To improve performance of uplink analog beamforming (ABF), aspects provided herein may enable a user equipment (UE) to report a dynamic capability that indicates a potential of upgrading a power class of the UE when uplink ABF (otherwise referred to as an “uplink ABF scheme”) is being used, instead of a static capability that has a fixed power class associated with each frequency range supported by the UE. By enabling more flexible uplink ABF with power class upgrading/downgrading potential, the performance gain realized by ABF may be improved. The network may dynamically instruct the UE to adjust its power class (such as downgrading the power class) due to potential interference that may be caused by the upgraded power class. In some aspects, there may be a maximum power per antenna (P_{CMAX}) when ABF is used. Therefore, if ABF is used across multiple discrete antennas that each have its own P_{CMAX}, the power class of the UE may be upgraded.

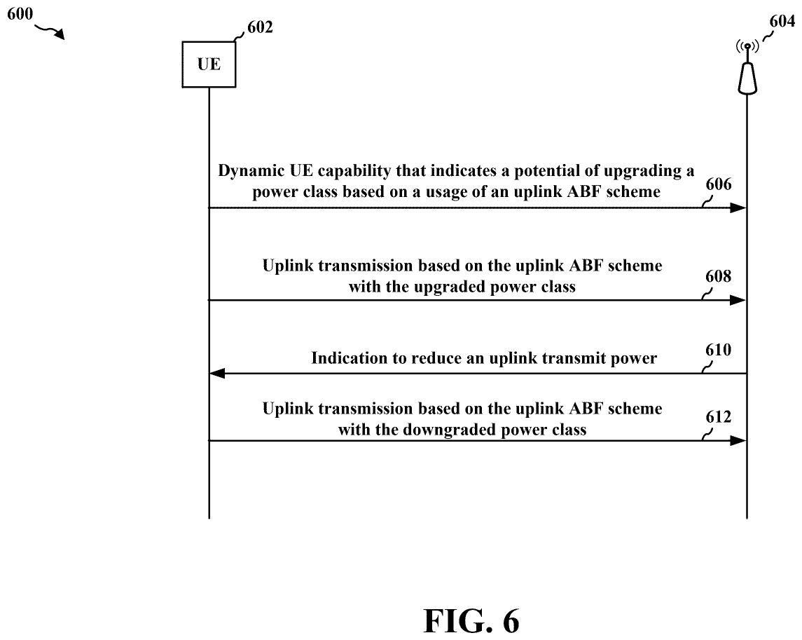

FIG. 6 is a diagram 600 illustrating example communications between a network entity 604 and a UE 602. As illustrated in FIG. 6, the UE 602 may transmit a dynamic capability 606 that indicates a potential of upgrading a power class based on a usage of an uplink ABF scheme. In some aspects, the dynamic capability 606 indicates whether the UE 602 is subject to a total conducted or radiated power constraint, or whether it has a maximum power that may be used on a per-antenna basis. If the UE 602 is subject to a total conducted or radiated power constraint, it may be inferred that the UE 602 may not have the potential of upgrading its power class based on the usage of the uplink ABF scheme. If the UE 602 has a maximum power that may be used on a per-antenna basis (e.g., a maximum power useable per antenna constraint), it may be inferred that the UE 602 may have the potential of upgrading its power class based on the usage of the uplink ABF scheme. In some aspects, the dynamic capability 606 indicates the static capabilities of power class(es) associated with the UE for each frequency range. For example, for each frequency band, the UE 602 may report (in the dynamic capability 606) a first power class associated with the UE when uplink ABF is not being used, and a second power class associated with the UE when uplink ABF is being used. If the second power class is different from the first power class, then the UE has the potential of upgrading its power class for that frequency band. If the second power class is the same as the first power class, then the UE does not have the potential of upgrading its power class for that frequency band. For the frequency bands where the UE does not have the potential of upgrading its power class, the UE may also report a single power class instead.

In some aspects, the upgraded power class may indicate whether the UE has a total power constraint (in which case the updated power class may be the same as the original power class) or a maximum power per antenna constraint (in which case the upgraded power class may capture how many antennas are ABFed per layer and the PA rating(s) that the antennas may have). As an example, for some frequency ranges (one or more frequency ranges supported by the UE), the UE may indicate a power class 2 (26 dBm P_{CMAX}) with no ABF, power class 1.5 (29 dBm P_{CMAX}) with ABF of two antennas and power class 1 (31 dBm PCMAX) with ABF of four antennas.

In some aspects, the UE 602 may transmit an uplink transmission 608 to the network entity 604 based on the uplink ABF scheme with the upgraded power class. In some aspects, the network entity 604 may determine that the transmission power of the uplink transmission 608 may cause interference (e.g., being above a threshold), and may transmit an indication 610 to downgrade the power class to the UE 602. In some aspects, the network entity 604 may also identify a victim node based on a first scheduling information associated with the UE 602 and a second scheduling information associated with the victim node (which may be another UE such as a UE operating in DL mode, or a different network node, such as a neighbor cell). After receiving the indication 610, the UE 602 may downgrade its power class (and reduce the UL transmit power), and transmit a second uplink transmission 612 based on the downgraded (e.g., non-upgraded) power class.

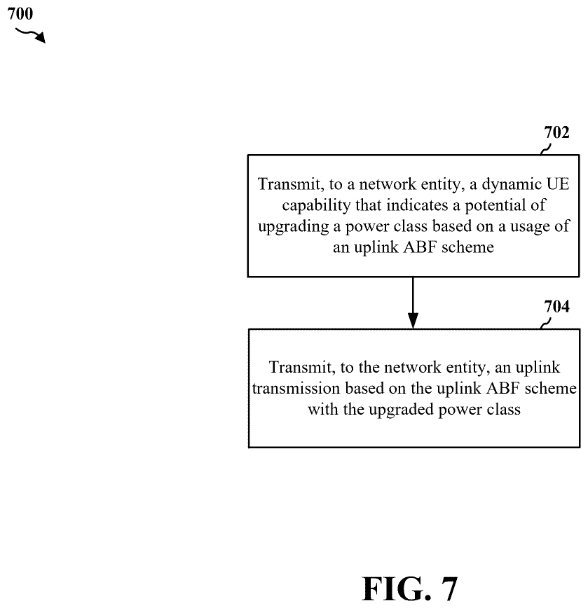

FIG. 7 is a flowchart 700 of a method of wireless communication. The method may be performed by a UE (e.g., the UE 104, the UE 602; the apparatus 904).

At 702, the UE may transmit, to a network entity, a dynamic UE capability that indicates a potential of upgrading a power class based on a usage of an uplink ABF scheme. For example, the UE 602 may transmit, to a network entity 604, a dynamic UE capability (e.g., 606) that indicates a potential of upgrading a power class based on a usage of an uplink ABF scheme. In some aspects, 702 may be performed by ABF component 198.

At 704, the UE may transmit, to the network entity, an uplink transmission based on the uplink ABF scheme with the upgraded power class. For example, the UE 602 may transmit, to the network entity (e.g., 604), an uplink transmission 608 based on the uplink ABF scheme with the upgraded power class. In some aspects, 704 may be performed by ABF component 198.

In some aspects, the UE may receive, from the network entity, an indication (e.g., 610) to reduce an uplink transmit power after transmission of the uplink transmission. In some aspects, the indication to reduce the uplink transmit power indicates a downgrade of the power class.

In some aspects, the dynamic UE capability is based on a signaling that indicates whether the UE is associated with a maximum power useable per antenna constraint or a total conducted or radiated power constraint across all antennas associated with the UE. In some aspects, the dynamic UE capability is based on a signaling that indicates, for each band supported by the UE, the power class and an upgraded power class based on the usage of the uplink ABF scheme. In some aspects, the upgraded power class is based on a quantity of a set of antennas associated with the uplink ABF scheme per layer and a set of power amplifier ratings associated with the set of antennas used in the uplink ABF scheme. In some aspects, the upgraded power class based on the usage of the uplink ABF scheme is different from the power class if the UE is associated with a maximum power per antenna constraint. In some aspects, the upgraded power class based on the usage of the uplink ABF scheme is same as the power class if the UE is associated with a total conducted or radiated power constraint across all antennas associated with the UE.

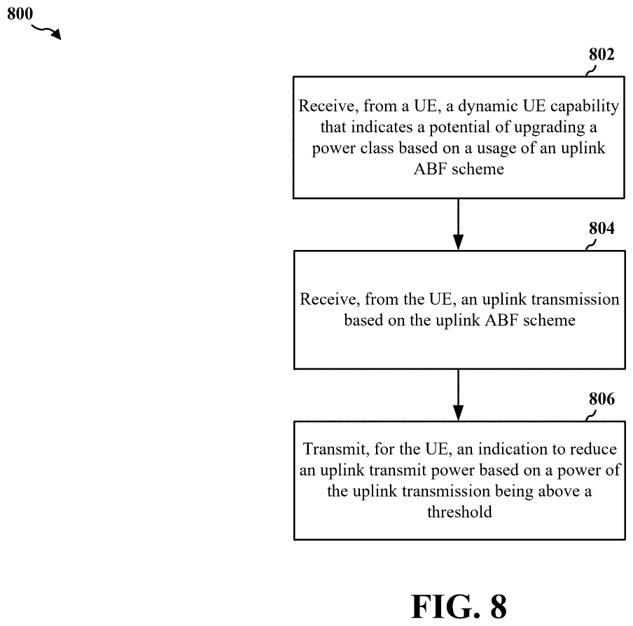

FIG. 8 is a flowchart 800 of a method of wireless communication. The method may be performed by a network entity (e.g., the base station 102, the network entity 604, the network entity 902, the network entity 1002).

At 802, the network entity may receive, from a UE, a dynamic UE capability that indicates a potential of upgrading a power class based on a usage of an uplink ABF scheme. For example, the network entity 604 may receive, from a UE 602, a dynamic UE capability (e.g., 606) that indicates a potential of upgrading a power class based on a usage of an uplink ABF scheme. In some aspects, 802 may be performed by ABF component 199.

At 804, the network entity may receive, from the UE, an uplink transmission based on the uplink ABF scheme. For example, the network entity 604 may receive, from the UE 602, an uplink transmission (e.g., 608) based on the uplink ABF scheme. In some aspects, 804 may be performed by ABF component 199.

At 806, the network entity may transmit, for the UE, an indication to reduce an uplink transmit power based on a power of the uplink transmission being above a threshold. For example, the network entity 604 may transmit, for the UE 602, an indication (e.g., 610) to reduce an uplink transmit power based on a power of the uplink transmission being above a threshold. In some aspects, 806 may be performed by ABF component 199.

In some aspects, the threshold is based on a potential cross-link interference associated with a victim node of the uplink transmission. In some aspects, the network entity may identify the victim node based on a first scheduling information associated with the UE and a second scheduling information associated with the victim node. In some aspects, the indication to reduce the uplink transmit power indicates a downgrade of the power class. In some aspects, the dynamic UE capability is based on a signaling that indicates whether the UE is associated with a maximum power per antenna constraint or a total conducted or radiated power constraint across all antennas associated with the UE. In some aspects, the dynamic UE capability is based on a signaling that indicates, for each band supported by the UE, the power class and an upgraded power class based on the usage of the uplink ABF scheme. In some aspects, the upgraded power class is based on a quantity of a set of antennas associated with the uplink ABF scheme per layer and a set of power amplifier ratings associated with the set of antennas.

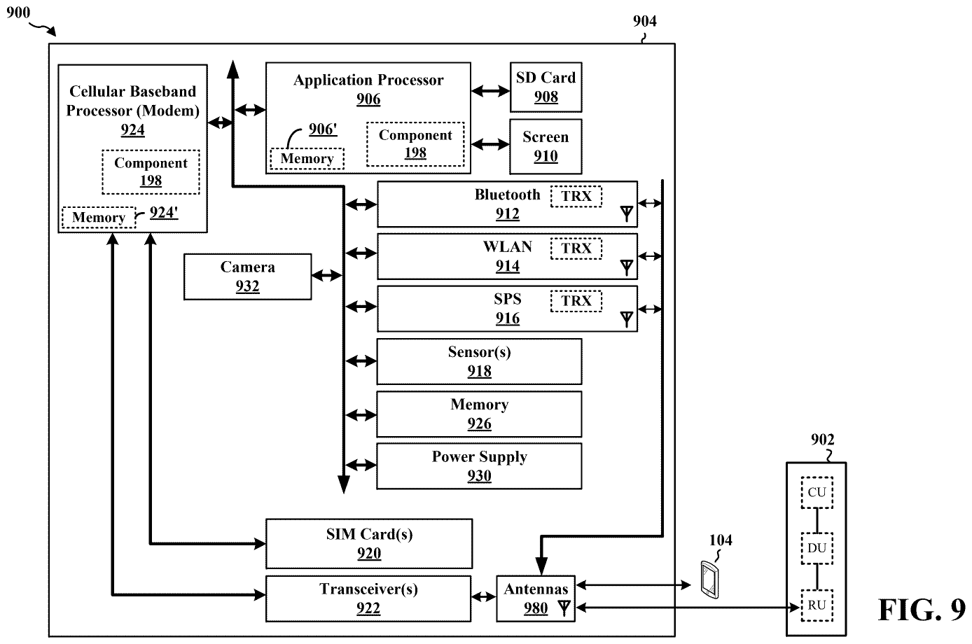

FIG. 9 is a diagram 900 illustrating an example of a hardware implementation for an apparatus 904. The apparatus 904 may be a UE, a component of a UE, or may implement UE functionality. In some aspects, the apparatus 904 may include at least one cellular baseband processor 924 (also referred to as a modem) coupled to one or more transceivers 922 (e.g., cellular RF transceiver). The cellular baseband processor(s) 924 may include at least one on-chip memory 924′. In some aspects, the apparatus 904 may further include one or more subscriber identity modules (SIM) cards 920 and at least one application processor 906 coupled to a secure digital (SD) card 908 and a screen 910. The application processor(s) 906 may include on-chip memory 906′. In some aspects, the apparatus 904 may further include a Bluetooth module 912, a WLAN module 914, an SPS module 916 (e.g., GNSS module), one or more sensor modules 918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 926, a power supply 930, and/or a camera 932. The Bluetooth module 912, the WLAN module 914, and the SPS module 916 may include an on-chip transceiver (TRX) (or in some cases, just a receiver (RX)). The Bluetooth module 912, the WLAN module 914, and the SPS module 916 may include their own dedicated antennas and/or utilize the antennas 980 for communication. The cellular baseband processor(s) 924 communicates through the transceiver(s) 922 via one or more antennas 980 with the UE 104 and/or with an RU associated with a network entity 902. The cellular baseband processor(s) 924 and the application processor(s) 906 may each include a computer-readable medium/memory 924′, 906′, respectively. The additional memory modules 926 may also be considered a computer-readable medium/memory. Each computer-readable medium/memory 924′, 906′, 926 may be non-transitory. The cellular baseband processor(s) 924 and the application processor(s) 906 are each responsible for general processing, including the execution of software stored on the computer-readable medium/memory. The software, when executed by the cellular baseband processor(s) 924/application processor(s) 906, causes the cellular baseband processor(s) 924/application processor(s) 906 to perform the various functions described supra. The computer-readable medium/memory may also be used for storing data that is manipulated by the cellular baseband processor(s) 924/application processor(s) 906 when executing software. The cellular baseband processor(s) 924/application processor(s) 906 may be a component of the UE 350 and may include the at least one memory 360 and/or at least one of the TX processor 368, the RX processor 356, and the controller/processor 359. In one configuration, the apparatus 904 may be at least one processor chip (modem and/or application) and include just the cellular baseband processor(s) 924 and/or the application processor(s) 906, and in another configuration, the apparatus 904 may be the entire UE (e.g., see UE 350 of FIG. 3) and include the additional modules of the apparatus 904.

As discussed supra, the ABF component 198 may be configured to transmit, to a network entity, a dynamic UE capability that indicates a potential of upgrading a power class based on a usage of an uplink ABF scheme. In some aspects, the ABF component 198 may be further configured to transmit, to the network entity, an uplink transmission based on the uplink ABF scheme with the upgraded power class. The ABF component 198 may be within the cellular baseband processor(s) 924, the application processor(s) 906, or both the cellular baseband processor(s) 924 and the application processor(s) 906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 904 may include a variety of components configured for various functions. In one configuration, the apparatus 904, and in particular the cellular baseband processor(s) 924 and/or the application processor(s) 906, may include means for transmitting, to a network entity, a dynamic UE capability that indicates a potential of upgrading a power class based on a usage of an uplink ABF scheme. In some aspects, the apparatus 904 may include means for transmitting, to the network entity, an uplink transmission based on the uplink ABF scheme with the upgraded power class. In some aspects, the apparatus 904 may include means for receiving, from the network entity, an indication to reduce an uplink transmit power after transmission of the uplink transmission. In some aspects, the apparatus 904 may include means for transmitting, based on the indication a second uplink transmission based on the power class instead of the upgraded power class. The means may be the component 198 of the apparatus 904 configured to perform the functions recited by the means. As described supra, the apparatus 904 may include the TX processor 368, the RX processor 356, and the controller/processor 359. As such, in one configuration, the means may be the TX processor 368, the RX processor 356, and/or the controller/processor 359 configured to perform the functions recited by the means.

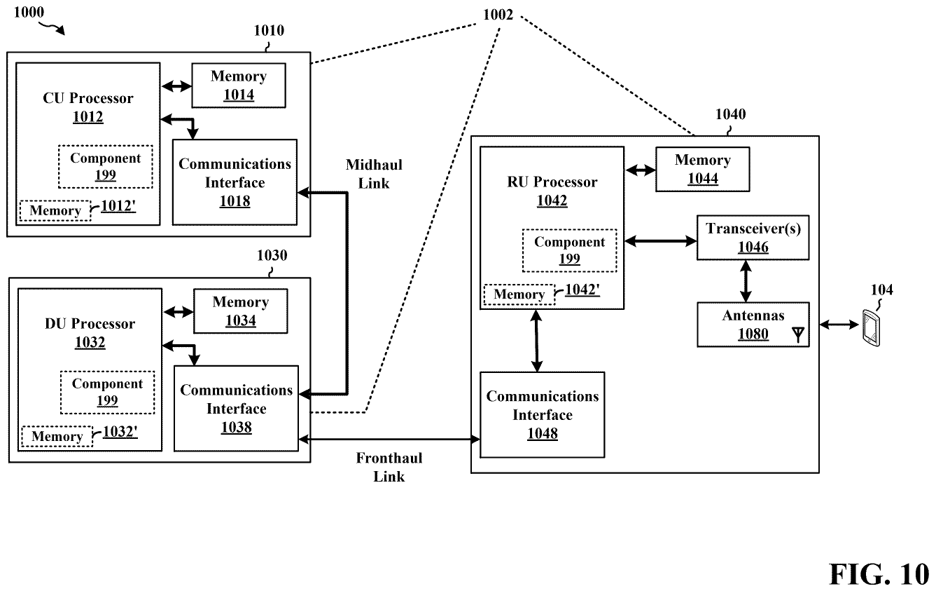

FIG. 10 is a diagram 1000 illustrating an example of a hardware implementation for a network entity 1002. The network entity 1002 may be a BS, a component of a BS, or may implement BS functionality. The network entity 1002 may include at least one of a CU 1010, a DU 1030, or an RU 1040. For example, depending on the layer functionality handled by the component 199, the network entity 1002 may include the CU 1010; both the CU 1010 and the DU 1030; each of the CU 1010, the DU 1030, and the RU 1040; the DU 1030; both the DU 1030 and the RU 1040; or the RU 1040. The CU 1010 may include at least one CU processor 1012. The CU processor(s) 1012 may include on-chip memory 1012′. In some aspects, the CU 1010 may further include additional memory modules 1014 and a communications interface 1018. The CU 1010 communicates with the DU 1030 through a midhaul link, such as an F1 interface. The DU 1030 may include at least one DU processor 1032. The DU processor(s) 1032 may include on-chip memory 1032′. In some aspects, the DU 1030 may further include additional memory modules 1034 and a communications interface 1038. The DU 1030 communicates with the RU 1040 through a fronthaul link. The RU 1040 may include at least one RU processor 1042. The RU processor(s) 1042 may include on-chip memory 1042′. In some aspects, the RU 1040 may further include additional memory modules 1044, one or more transceivers 1046, antennas 1080, and a communications interface 1048. The RU 1040 communicates with the UE 104. The on-chip memory 1012′, 1032′, 1042′ and the additional memory modules 1014, 1034, 1044 may each be considered a computer-readable medium/memory. Each computer-readable medium/memory may be non-transitory. Each of the processors 1012, 1032, 1042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the ABF component 199 may be configured to receive, from a UE, a dynamic UE capability that indicates a potential of upgrading a power class based on a usage of an uplink ABF scheme. In some aspects, the ABF component 199 may be further configured to receive, from the UE, an uplink transmission based on the uplink ABF scheme. In some aspects, the ABF component 199 may be further configured to transmit, for the UE, an indication to reduce an uplink transmit power based on a power of the uplink transmission being above a threshold. The ABF component 199 may be within one or more processors of one or more of the CU 1010, DU 1030, and the RU 1040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1002 may include a variety of components configured for various functions. In one configuration, the network entity 1002 may include means for receiving, from a UE, a dynamic UE capability that indicates a potential of upgrading a power class based on a usage of an uplink ABF scheme. In some aspects, the network entity 1002 may include means for receiving, from the UE, an uplink transmission based on the uplink ABF scheme. In some aspects, the network entity 1002 may include means for transmitting, for the UE, an indication to reduce an uplink transmit power based on a power of the uplink transmission being above a threshold. In some aspects, the network entity 1002 may include means for identifying the victim node based on a first scheduling information associated with the UE and a second scheduling information associated with the victim node. In some aspects, the network entity 1002 may include means for receiving a second uplink transmission based on the power class instead of the upgraded power class. The means may be the component 199 of the network entity 1002 configured to perform the functions recited by the means. As described supra, the network entity 1002 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory, based at least in part on information stored in the at least one memory, the at least one processor is configured to: transmit, to a network entity, a dynamic UE capability that indicates a potential of upgrading a power class based on a usage of an uplink analog beamforming (ABF) scheme; and transmit, to the network entity, an uplink transmission based on the uplink ABF scheme with the upgraded power class.

Aspect 2 is the apparatus of aspect 1, where the at least one processor is further configured to: receive, from the network entity, an indication to reduce an uplink transmit power after transmission of the uplink transmission.

Aspect 3 is the apparatus of aspect 2, where the indication to reduce the uplink transmit power indicates a downgrade of the power class.

Aspect 4 is the apparatus of any of aspects 1-3, where the dynamic UE capability is based on a signaling that indicates whether the UE is associated with a maximum power useable per antenna constraint or a total conducted or radiated power constraint across all antennas associated with the UE.

Aspect 5 is the apparatus of any of aspects 1-4, where the dynamic UE capability is based on a signaling that indicates, for each band supported by the UE, the power class and an upgraded power class based on the usage of the uplink ABF scheme.

Aspect 6 is the apparatus of aspect 5, where the upgraded power class is based on a quantity of a set of antennas associated with the uplink ABF scheme per layer and a set of power amplifier ratings associated with the set of antennas used in the uplink ABF scheme.

Aspect 7 is the apparatus of any of aspects 5-6, where the upgraded power class is different from the power class based on the UE being associated with a maximum power per antenna constraint.

Aspect 8 is the apparatus of any of aspects 5-6, where the upgraded power class is equivalent to the power class based on the UE being associated with a total conducted or radiated power constraint across all antennas associated with the UE.

Aspect 9 is an apparatus for wireless communication at a network entity, including: at least one memory; and at least one processor coupled to the at least one memory, based at least in part on information stored in the at least one memory, the at least one processor is configured to: receive, from a user equipment (UE), a dynamic UE capability that indicates a potential of upgrading a power class based on a usage of an uplink analog beamforming (ABF) scheme; and receive, from the UE, an uplink transmission based on the uplink ABF scheme.

Aspect 10 is the apparatus of aspect 9, where the at least one processor is further configured to: transmit, for the UE, an indication to reduce an uplink transmit power based on a power of the uplink transmission being above a threshold.

Aspect 11 is the apparatus of aspect 10, where the threshold is based on a potential cross-link interference associated with a victim node of the uplink transmission, and where the at least one processor is configured to: identify the victim node based on a first scheduling information associated with the UE and a second scheduling information associated with the victim node.

Aspect 12 is the apparatus of aspect 11, where the indication to reduce the uplink transmit power indicates a downgrade of the power class.

Aspect 13 is the apparatus of any of aspects 9-12, where the dynamic UE capability is based on a signaling that indicates whether the UE is associated with a maximum power per antenna constraint or a total conducted or radiated power constraint across all antennas associated with the UE.

Aspect 14 is the apparatus of any of aspects 9-13, where the dynamic UE capability is based on a signaling that indicates, for each band supported by the UE, the power class and an upgraded power class based on the usage of the uplink ABF scheme.

Aspect 15 is the apparatus of aspect 14, where the upgraded power class is based on a quantity of a set of antennas associated with the uplink ABF scheme per layer and a set of power amplifier ratings.

Aspect 16 is a method of wireless communication for implementing any of aspects 1 to 15.

Aspect 17 is a computer-readable medium (e.g., a non-transitory computer-readable medium) storing computer executable code, the code when executed by at least one processor causes the at least one processor to implement any of aspects 1 to 15.

Aspect 18 is an apparatus comprising means for implementing any of aspects 1 to 15.

What is claimed is:

1. An apparatus for wireless communication at a user equipment (UE), comprising:
at least one memory; and
at least one processor coupled to the at least one memory, based at least in part on information stored in the at least one memory, the at least one processor is configured to:
transmit, to a network entity, a dynamic UE capability that indicates a potential of upgrading a power class based on a usage of an uplink analog beamforming (ABF) scheme; and
transmit, to the network entity, an uplink transmission based on the uplink ABF scheme with the upgraded power class.

2. The apparatus of claim 1, wherein the at least one processor is further configured to:
receive, from the network entity, an indication to reduce an uplink transmit power after transmission of the uplink transmission.

3. The apparatus of claim 2, wherein the indication to reduce the uplink transmit power indicates a downgrade of the power class.

4. The apparatus of claim 1, wherein the dynamic UE capability is based on a signaling that indicates whether the UE is associated with a maximum power useable per antenna constraint or a total conducted or radiated power constraint across all antennas associated with the UE.

5. The apparatus of claim 1, wherein the dynamic UE capability is based on a signaling that indicates, for each band supported by the UE, the power class and an upgraded power class based on the usage of the uplink ABF scheme.

6. The apparatus of claim 5, wherein the upgraded power class is based on a quantity of a set of antennas associated with the uplink ABF scheme per layer and a set of power amplifier ratings associated with the set of antennas used in the uplink ABF scheme.

7. The apparatus of claim 5, wherein the upgraded power class is different from the power class based on the UE being associated with a maximum power per antenna constraint.

8. The apparatus of claim 5, wherein the upgraded power class is equivalent to the power class based on the UE being associated with a total conducted or radiated power constraint across all antennas associated with the UE.

9. An apparatus for wireless communication at a network entity, comprising:
at least one memory; and
at least one processor coupled to the at least one memory, based at least in part on information stored in the at least one memory, the at least one processor is configured to:
receive, from a user equipment (UE), a dynamic UE capability that indicates a potential of upgrading a power class based on a usage of an uplink analog beamforming (ABF) scheme; and
receive, from the UE, an uplink transmission based on the uplink ABF scheme. 10 The apparatus of claim 9, wherein the at least one processor is further configured to:
transmit, for the UE, an indication to reduce an uplink transmit power based on a power of the uplink transmission being above a threshold.

11. The apparatus of claim 10, wherein the threshold is based on a potential cross-link interference associated with a victim node of the uplink transmission, and wherein the at least one processor is configured to:
identify the victim node based on a first scheduling information associated with the UE and a second scheduling information associated with the victim node.

12. The apparatus of claim 11, wherein the indication to reduce the uplink transmit power indicates a downgrade of the power class.

13. The apparatus of claim 9, wherein the dynamic UE capability is based on a signaling that indicates whether the UE is associated with a maximum power per antenna constraint or a total conducted or radiated power constraint across all antennas associated with the UE.

14. The apparatus of claim 9, wherein the dynamic UE capability is based on a signaling that indicates, for each band supported by the UE, the power class and an upgraded power class based on the usage of the uplink ABF scheme.

15. The apparatus of claim 14, wherein the upgraded power class is based on a quantity of a set of antennas associated with the uplink ABF scheme per layer and a set of power amplifier ratings associated with the set of antennas.

16. A method of wireless communication performed by a user equipment (UE), comprising:
transmitting, to a network entity, a dynamic UE capability that indicates a potential of upgrading a power class based on a usage of an uplink analog beamforming (ABF) scheme; and
transmitting, to the network entity, an uplink transmission based on the uplink ABF scheme with the upgraded power class.

17. The method of claim 16, further comprising:
receiving, from the network entity, an indication to reduce an uplink transmit power after transmission of the uplink transmission.

18. The method of claim 16, wherein the indication to reduce the uplink transmit power indicates a downgrade of the power class.

19. The method of claim 16, wherein the dynamic UE capability is based on a signaling that indicates whether the UE is associated with a maximum power useable per antenna constraint or a total conducted or radiated power constraint across all antennas associated with the UE.

20. The method of claim 16, wherein the dynamic UE capability is based on a signaling that indicates, for each band supported by the UE, the power class and an upgraded power class based on the usage of the uplink ABF scheme.
